(19) United States
(12) Patent Application Publication
(10) Pub. No.: US 2005/0023490 A1
(43) Pub. Date: Feb. 3, 2005

(54) Edge sensing of data storage media

(75) Inventors: Vernon M. Cottles, Maplewood, MN (US); Mark R. Drutowski, St. Paul, MN (US); Christopher A. Merton, Hammond, WI (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/629,074

(22) Filed: Jul. 29, 2003

(51) Int. Cl. G01V 8/00; G01N 21/86

(52) U.S. Cl. 250/559.36; 250/559.29; 356/635

(57) ABSTRACT

The invention is directed to devices and methods for sensing one or more edges of a data storage medium, such as magnetic data recording tape. An edge sensor in a media-handling device includes a light emitter that emits a beam of light, a mirror that reflects at least a portion of the emitted beam and a collector that receives at least a portion of the reflected portion. The medium blocks some of the light, preventing the light from being collected by the collector. The invention is directed to an embodiment in which the light emitter and collector are disposed on one side of the medium, and the mirror is disposed on the other side of the medium. The invention is also directed to an embodiment in which at least a portion of the emitted beam of light is directed obliquely to a plane defined by the medium.

### TECHNICAL FIELD

The invention relates to handling media such as data storage media. In particular, the invention relates to sensing the position of an edge of a data storage medium.

### BACKGROUND

Sensing the position of one or more edges of a data storage medium, such as magnetic tape, is useful in many circumstances. For example, the capability to sense an edge position is useful in research and development of the medium itself. Information about edge position may be useful for determining whether the medium is of the proper width, for example.

Information about edge position may also be useful when evaluating performance of a media-handling device, i.e., devices such as drives that move media of a particular kind in a controlled fashion. For example, this information may be valuable when inspecting, troubleshooting or calibrating the media-handling device. Information about edge position may also be used during ordinary operation of the media-handling device. A media-handling device may use such information to control the motion of the medium, for example, or to control a head that reads data from or writes data to the medium.

### SUMMARY

In general, the invention is directed to devices and methods for sensing one or more edges of a data storage medium. An edge sensor in a media-handling device optically senses the edge of the medium. The edge sensor includes a light emitter that emits a beam of light, a mirror that reflects at least a portion of the emitted beam and a collector that receives at least a portion of the reflected portion of the emitted beam. The edge sensor is deployed so that the medium may block some of the light, preventing the light from being collected by the collector. When the edge of the medium is in one position, the medium blocks more light than when the edge is in another position. Accordingly, the amount of collected light is a function of the position of the edge.

In one embodiment, the invention is directed to an edge sensor that includes the light emitter and collector disposed on one side of the data storage medium, and the mirror disposed on the other side of the medium. In another embodiment, the invention is directed to an edge sensor in which at least a portion of the emitted beam of light is directed obliquely to a plane defined by the data storage medium.

These embodiments are useful in many kinds of media-handling devices, including media-handling devices such as drives that employ automatic loading of the medium. Edge sensors constructed in accordance with the invention do not encroach upon the path of the medium and do not come in contact with the medium during loading. The mirror may be deployed to define a clearance that separates the mirror from contact with the medium. As a result, it is not necessary for the automatic loading apparatus to avoid the edge sensor during load; nor is it necessary to move the edge sensor out of the way during loading.

In these embodiments of the invention, the light emitter may include a light source. A typical light source may comprise a laser or a light emitting diode. Similarly, the collector may include a detector that generates a signal as a function of the quantity of light received by the collector. A typical detector may comprise a single-cell photodiode.

Various embodiments of the invention include optical elements to direct the light. Such optical elements may include a beam-splitter, another mirror, a collimating apparatus, a lens or focusing apparatus, and optical fibers.

In another embodiment of the invention, a light source and a detector may be coupled externally to the media-handling device, supplying light to the emitter by and receiving light from the collector by one or more optical conduits. This embodiment is directed to a device comprising a first optical conduit configured to emit a beam of light when a light source is coupled to the first optical conduit, a mirror to reflect at least a portion of the emitted beam, and a second optical conduit configured to receive at least a portion of the reflected portion of the emitted beam, and configured to be coupled to a detector. This embodiment may be advantageous in applications such as inspection, troubleshooting and calibration of media-handling devices, or in other circumstances in which it may not be practical or economical to install a light source and detector in a media-handling device.

In a further embodiment, the invention is directed to a media-handling device that includes an edge sensor as described herein.

In an additional embodiment, the invention presents a method comprising emitting a beam of light from a first side of a medium, and collecting at least a portion of the emitted beam on the first side of the medium. The collected portion of light includes light reflected in a mirror disposed on a second side of the medium and unblocked by the medium.

The various embodiments may offer one or more advantages, some of which have already been mentioned. The various embodiments of the invention may be incorporated into the design of a media-handling device, or may be added on to a previously existing design. The invention is versatile in application, and although the invention will be described in the context of magnetic tape and a tape-handling device, the invention may be configured to work with a variety of media and media-handling devices.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a perspective diagram of an exemplary media-handling device, in particular, a tape-handling device, illustrating two exemplary deployments of an edge sensor in accordance with an embodiment of the invention.

FIG. 2 is a perspective diagram of one embodiment of an edge sensor, including a light emitter, beam splitter, mirror and collector.

FIG. 3 is a perspective diagram of the edge sensor depicted in FIG. 2, with the edge sensor cooperating with a bearing surface that bears a tape.

FIG. 4 is a plan diagram of the edge sensor depicted in FIG. 2.

FIG. 5 is a plan diagram of another embodiment of an edge sensor.

FIG. 6 is a plan diagram of another embodiment of an edge sensor.

FIG. 7 is a plan diagram of another embodiment of an edge sensor, with an attachable light source and detector.

FIG. 8 is a plan diagram of another embodiment of an edge sensor, with an attachable light source and detector.

FIG. 9 is a flow diagram illustrating techniques for using the embodiments shown in FIGS. 7 and 8.

FIG. 10 is a plan diagram of another embodiment of an edge sensor.

FIG. 11 is a plan diagram of another embodiment of an edge sensor.

### DETAILED DESCRIPTION

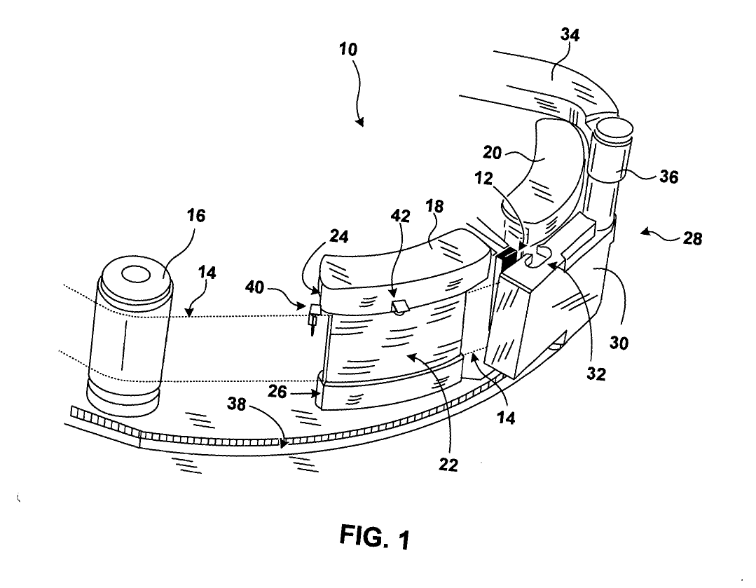

FIG. 1 is a perspective diagram of an exemplary media-handling device that may employ the invention. The exemplary media-handling device includes handling apparatus to move one or more media in a controlled fashion. Handling apparatus includes mechanisms such as reels, guides, drives, loaders and the like.

The exemplary media-handling device shown in FIG. 1 is a tape-handling device 10, and in particular, exemplary tape-handling device 10 is a magnetic tape drive, i.e., a device for reading and recording data to magnetic data recording tape (not shown in FIG. 1) with a read/write head 12. The handling apparatus of tape-handling device 10 may include one or more mechanisms that draw the tape past read/write head 12.

Although the invention will be described in the context of handling magnetic tape, the invention has applicability to devices that handle other media. The media may be in tape form, such as optical recording tape, or in some other form, such as a disk. Moreover, the invention may be applied to contexts other than writing or reading data from a medium.

In tape-handling device 10, head 12 may include one or more transducers for reading data from the tape or writing data to the tape. When exemplary device 10 is handling the tape, the tape follows a tape path 14. The tape may be stored in a cartridge or on a reel (not shown), and may be drawn across a guide 16. The tape may then be drawn across a bearing element 18, which positions the tape for reading or writing by head 12. After the tape has passed head 12, the tape may be drawn across a second bearing element 20, which may be structurally similar to bearing element 18.

Bearing element 18 includes a bearing surface 22. When tape following tape path 14 is pulled taut, the tape contacts bearing element 18 on bearing surface 22. As shown in FIG. 1, bearing element 18 includes flanges 24, 26 that keep the tape on bearing surface 22 and that constrain, but do not eliminate, lateral tape motion. In exemplary device 10, lateral tape motion comprises up and down motion of the tape, which is perpendicular to the motion of the tape past head 12.

Lateral tape motion may interfere with reading from or writing to a tape. The data stored on the tape may be organized into “data tracks,” and head 12 may write data to or read data from the data tracks, or both. A typical tape includes several data tracks. For proper data storage and recovery, head 12 must locate each track where data are to be written or read, and follow the path of the data track accurately along the media surface. A servo controller (not shown) typically is provided to control the positioning of head 12 relative to the data tracks.

To facilitate reading and writing, pre-recorded servo position information may be included at pre-selected sites on the tape. This servo position information may be used by the servo controller to control the motion of head 12 when seeking between tracks, and to regulate the position of head 12 on a data track during reading and/or writing. The servo information is stored in specialized “servo tracks” on the tape. Under ordinary operating conditions, the servo controller may compensate for lateral tape motion by monitoring the position of the servo tracks.

Exemplary tape-handling device 10 includes an automatic loading apparatus 28. Automatic loading apparatus 28 retrieves an end of the tape and pulls the tape along tape path 14. In FIG. 1, automatic loading apparatus 28 includes a grasping element 30. Grasping element 30 includes a grasping structure 32, which engages and pulls a complementary structure on the tape. In the example of FIG. 1, grasping structure 32 is a slot that receives a leader pin affixed to an end of the tape. Automatic loading apparatus 28 may include a grasping element that is configured to engage and pull tapes with other leader structures, such as leader blocks.

In the example of FIG. 1, automatic loading apparatus 28 includes an armature 34 coupled to grasping element 30 with a pivot structure 36. Armature 34 sweeps over guide 16, bearing element 18, head 12 and bearing element 20, pulling grasping element 30 via pivot structure 36. Grasping element 30 rides in groove 38. When grasping structure 32 of grasping element 30 has engaged the complementary leader structure on the tape, armature 34 pulls grasping element 30 past guide 16, bearing element 18, head 12 and bearing element 20. In this way, automatic loading apparatus 28 automatically loads the tape along tape path 14.

Exemplary tape-handling device 10 includes a stand-alone edge sensor 40. Tape-handling device 10 further includes an edge sensor 42 incorporated into bearing element 18. FIG. 1 illustrates examples of deployment of edge sensors. A typical tape-handling device may include more or fewer edge sensors than are depicted in FIG. 1, and may have edge sensors deployed in different configurations.

Stand-alone edge sensor 40 may be coupled to bearing element 18. Stand-alone edge sensor 40 may be deployed at any site along tape path 14. Accordingly, stand-alone edge sensor 40 may be added to a previously established configuration of a tape-handling device. In other words, stand-alone edge sensor 40 may be an “add-on” sensor, and may be anchored to the tape-handling device in any fashion.

Edge sensor 42, by contrast, is built into bearing element 18 of tape-handling device 10. That is, bearing element 18 serves as an anchor for edge sensor 42. The deployment of edge sensor 42 shown in FIG. 1 is illustrative, and edge sensor 42 may be deployed elsewhere along tape path 14.

In FIG. 1, edge sensors 40 and 42 are shown deployed to sense the top edge of the tape before the tape passes head 12. One or more edge sensors may be deployed to sense the bottom edge of the tape. In addition, one or more edge sensors may also be deployed to sense an edge of the tape after the tape passes head 12.

Many embodiments of edge sensors will be described below. Notably, edge sensors 40, 42 do not encroach upon tape path 14. In particular, when automatic loading apparatus 28 loads the tape along tape path 14, the tape will not come in contact with edge sensors 40, 42. Consequently, automatic loading apparatus 28 need not be modified to load the tape around either edge sensor 40, 42. Further, edge sensors 40, 42 need not be retracted or otherwise moved when the tape is loaded along tape path 14.

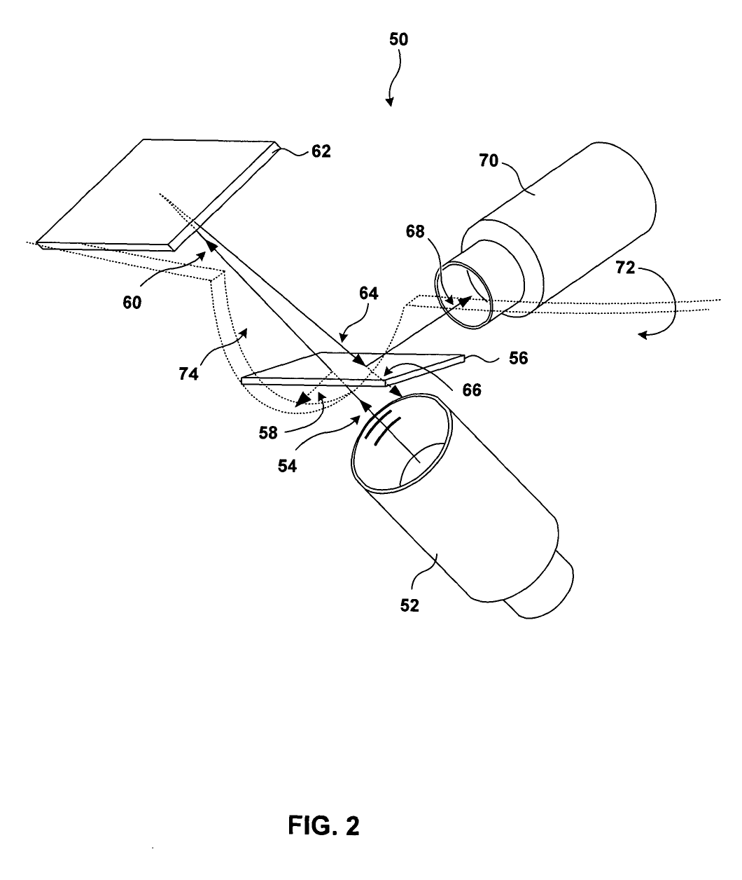

FIG. 2 is a perspective drawing illustrating the components of one embodiment of an edge sensor 50 in accordance with the invention. Edge sensor 50 includes a light emitter 52 that emits an incident beam of light 54. Light emitter 52 may include optical collimating elements, such as one or more lenses, that cause emitted beam 54 to be collimated. Light emitter 52 may include any of several light sources, including a laser such as a solid-state laser or a light-emitting diode. In some embodiments of the invention, light emitter 52 need not include a light source. In one configuration, for example, the light emitter comprises an optical conduit having a proximal end and a distal end, with the proximal end being coupled to a light source and the distal end emitting the beam of light. Other examples of configurations of light emitter 52 will be described below.

In the embodiment of edge sensor 50 shown in FIG. 2, incident beam 54 strikes a beam splitter 56. Beam splitter 56 is depicted in FIG. 2 as a partially reflective mirror that passes a known fraction of incident beam 54. In a typical embodiment, beam splitter 56 passes fifty percent of incident beam 54 and reflects fifty percent of incident beam 54. The reflected portion 58 of incident beam 54 is reflected away and is lost.

The beam portion 60 that passes through beam splitter 56 is directed toward a fully reflective mirror 62. In FIG. 2, reflective mirror 62 is a plane mirror, but as will be described below, other kinds of mirrors may be employed. The reflected beam 64 is directed back toward beam splitter 56. As shown in FIG. 2, reflected beam 64 reflects along a path different from that of incident beam portion 60. In some embodiments of the invention, however, reflective mirror 62 may be calibrated to reflect reflected beam 64 along the original incident path.

Reflected beam 64 strikes beam splitter 56. A known fraction 66 of reflected beam 64 passes through beam splitter 56 and is lost. The remaining portion 68 reflects from beam splitter 56 and is directed to a collector 70, which receives remaining portion 68. Collector 70 may include a detector that responds to the light collected by collector 70. For example, the detector may generate a signal as a function of the quantity of light received by the collector. An exemplary detector is a single-cell photodiode that generates an electrical signal as a function of the intensity of the detected light. The electrical signal may comprise a voltage signal, for example, that varies with the lateral tape motion. An example of a photodiode that may be used as a detector is a reverse biased, high-speed response silicon detector, approximately 15.0 square mm, with a responsivity of 0.55 A/W at a wavelength of 900 nm.

The detector may also include a signal processing module to process the generated signal. The signal processing module may, for example, compute the position of the edge of the tape as a function of the amount of light collected by collector 70. In some embodiments, the computed position of the edge may be used to finely adjust the tracking of head 12 during reading and writing operations. In other embodiments, the computed position of the edge may be used to inspect or troubleshoot the media-handling device.

The invention encompasses other kinds of detectors as well. Furthermore, the invention encompasses embodiments in which the collector need not include a detector. Some embodiments described below, for example, include a collector that is physically separated from a detector.

Beam splitter 56 may be disposed so as to allow different positions of light emitter 52 and collector 70. Use of beam splitter 56 causes some loss of light intensity, however, so edge sensor 50 is ordinarily calibrated to ignore losses of intensity that may be due to beam splitter 56.

The physical components of edge sensor 50, particularly light emitter 52, beam splitter 56, reflective mirror 62 and collector 70, may be coupled to a rigid framework or base (not shown). Coupling the components to a base preserves the alignment of the components with respect to one another, and also keeps the components at known distances from one another.

In a typical operation, not all of the portion 60 of incident light that passes through beam splitter 56 will strike reflective mirror 62. A tape will ordinarily block a fraction of incident light portion 60 from striking reflective mirror 62 and consequently being received by collector 70. As the tape blocks more of incident light portion 60, collector 70 collects less light, and consequently a detector coupled to collector 70 senses less light intensity. Conversely, as the tape blocks less of incident light portion 60, a detector coupled to collector 70 senses more light intensity. The intensity of the light reaching collector 70 is a function of the fraction of light blocked or not blocked by the tape, and the fraction of light blocked or not blocked by the tape is a function of the position of edge of the tape. In this way, the quantity of light received by collector 70 is a function of the position of the edge of the tape.

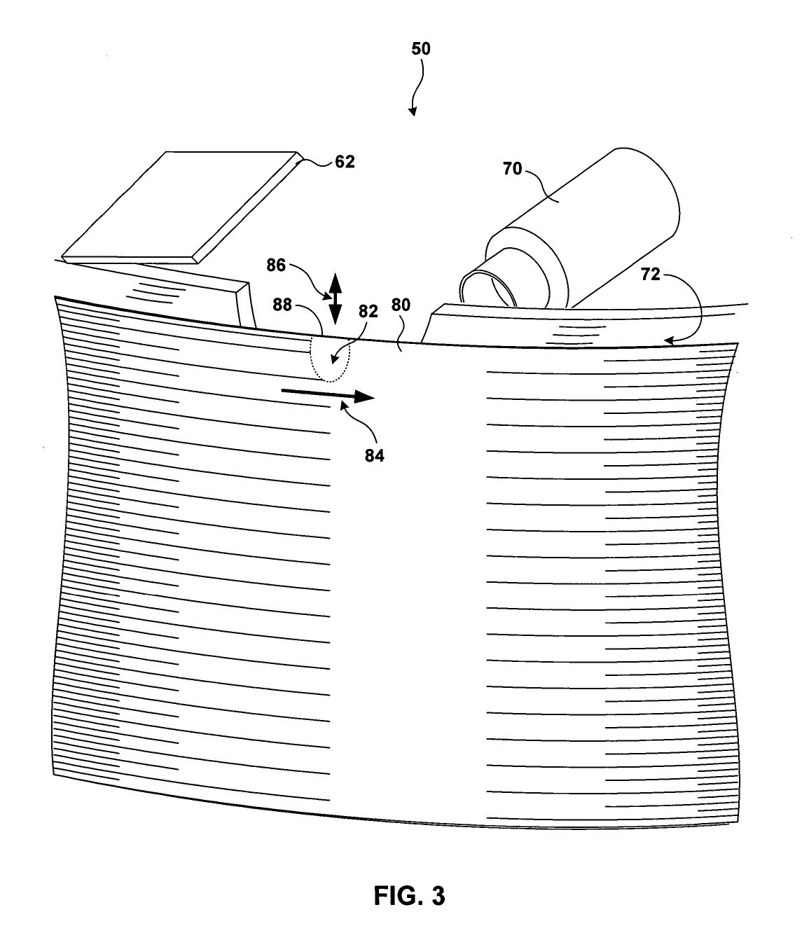

The tape may bear against a bearing surface 72, shown in dashed lines in FIG. 2. Light emitter 52, beam splitter 56 and collector 70 are deployed posteriorly with respect to bearing surface 72, while reflective mirror 62 is deployed anteriorly. When a tape bears against bearing surface 72 (as depicted in FIG. 3), light emitter 52, beam splitter 56 and collector 70 are on one side of the tape, and reflective mirror 60 is on the other side.

As depicted in FIG. 2, bearing surface 72 defines a notch 74. As the edge of a tape rides past notch 74, light from light emitter 52 passes through notch 74. Some of the emitted light is blocked by the tape as described above, and some is reflected by reflective mirror 62 and is received by collector 70.

Edge sensor 50 may therefore be deployed as part of a bearing element that includes bearing surface 72. In other words, edge sensor 50 may be deployed in a manner like edge sensor 42 in FIG. 1, which is deployed in conjunction with bearing element 18. It is not necessary that edge sensor 50 be deployed incorporated with a bearing element, however. Edge sensor 50 may also be deployed in a manner like edge sensor 40 shown in FIG. 1, i.e., as a stand-alone edge sensor.

FIG. 3 is a perspective drawing illustrating edge sensor 50 in an exemplary application, in accordance with the invention. FIG. 3 is like FIG. 2, except that some components of edge sensor 50 are hidden by bearing surface 72 and tape 80, which is pulled taut against bearing surface 72. Silhouette 82 represents the site on the reverse side of tape 80 at which light emitted by light emitter 52 strikes tape 80.

In FIG. 3, it is assumed that light emitter 52 emits a collimated circular beam. Silhouette 82, however, follows the contours of an ellipse, not a circle. This effect is due to the light emitter 52 directing the beam obliquely with respect to the plane of the tape. As will be described below, the invention encompasses embodiments in which the emitted beam of light is not a collimated circle.

Tape 80 moves past edge sensor 50 along the tape path direction indicated by reference numeral 84. Reference numeral 86 identifies the direction of “lateral motion,” i.e., a motion that is perpendicular to the direction of motion 84, with the tape bearing against bearing surface 72. In general, edge sensor 50 detects motion of tape 80 in lateral motion direction 86. Lateral motion of tape 80 causes edge 88 of tape 80 to move in lateral motion direction 86, causing tape 80 to block more or less light emitted by light emitter 52. When tape 80 blocks more light, collector 70 receives less light, and when tape 80 blocks less light, collector 70 receives more light.

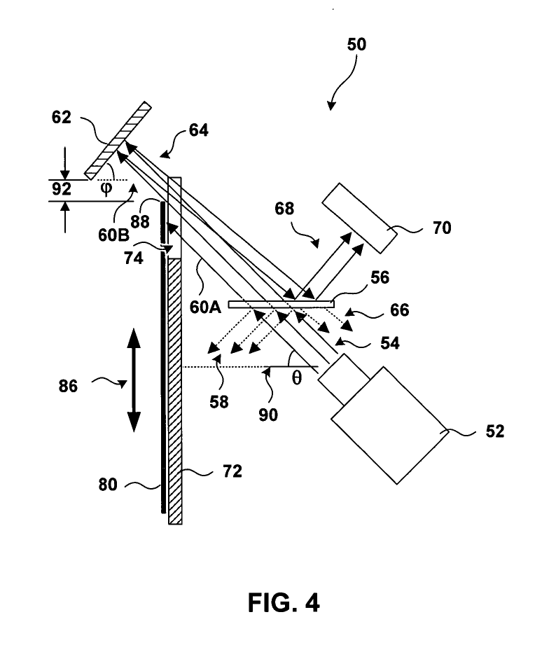

FIG. 4 presents a side view of edge sensor 50 in the exemplary application depicted in FIGS. 2 and 3. Tape 80 bears against bearing surface 72. Tape path direction 84 (not shown in FIG. 4) is out of the page. Light emitter 52 emits incident beam 54 that strikes beam splitter 56. FIG. 4 shows reflected portion 58 of incident beam 54 that is lost. The portion that passes through beam splitter 56 is directed toward a fully reflective mirror 62 is shown as portions 60A and 60B. Portion 60A passes through beam splitter 56, strikes tape 80 and is blocked. The remaining portion 60B passes through beam splitter 56, does not strike tape 80, and reaches reflective mirror 62. Mirror 62 directs reflected beam 64 toward beam splitter 56. Fraction 66 of reflected beam 64 passes through beam splitter 56 and is lost, but remaining portion 68 reflects from beam splitter 56 and is directed to collector 70.

FIG. 4 shows light emitter 52 directing the beam 54 obliquely with respect to a plane defined by tape 80. In FIG. 4, beam 54 is angled with respect to a perpendicular 90 of the plane of tape 80. The beam angle is denoted by θ.

Beam angle θ is a value between zero and 90 degrees. If beam angle θ were zero degrees, then the rays in the emitted beam would strike tape 80 perpendicularly, rather than obliquely. If beam angle θ were ninety degrees, then the rays in the emitted beam would not strike tape 80 at all, because the rays would be parallel to the plane defined by tape 80. In a typical application, beam angle θ may be approximately 45 degrees, but the invention encompasses embodiments in which other oblique angles are employed.

Tape 80 defines a plane and a perpendicular even if tape 80 is not strictly planar. A tape drawn across bearing surface 22 shown in FIG. 1, for example, follows a gentle bend across bearing surface 22. Even so, the plane defined by tape 80 may comprise a plane tangent to tape 80 proximate to the location where a portion of the emitted beam strikes tape 80, and the perpendicular may be any line perpendicular to the tangent plane.

Because light emitter 52 emits a beam of light obliquely to the plane of tape 80, mirror 62 may be deployed so as to define a clearance 92 with respect to edge 88 of tape 80. Clearance 92, which separates mirror 62 from contact with tape 80, is useful when tape 80 is loaded by an automatic loading apparatus, such as automatic loading apparatus 28 shown in FIG. 1. As the automatic loading apparatus pulls the tape taut against bearing surface 72, tape 80 does not come in contact with any of the components of edge sensor 50.

In particular, automatic loading of tape 80 will not bring tape 80 in contact with light emitter 52, beam splitter 56 or collector 70, because those components are disposed on the posterior side of bearing surface 72. Furthermore, automatic loading of tape 80 will not bring tape 80 in contact with mirror 62 because of clearance 92. Even though tape 80 may approach bearing surface 72 from the anterior side, and even though mirror 62 is disposed on the anterior side of bearing surface 72, tape 80 does not contact mirror 62 because mirror 62 is deployed to provide clearance 92.

In this way, light emitter 52 emits a beam of light obliquely to the plane of tape 80, resulting in clearance 92, which facilitates automatic loading of tape 80. During loading, edge sensor 50 need not be moved to avoid tape 80 during the loading process. Furthermore, tape 80 need not be moved in any special fashion to avoid edge sensor 50. This is advantageous when edge sensor 50 is added to a previously frozen configuration of a tape-handling device. Edge sensor 50 will not interfere with an automatic loader that is already in use.

The amount of light collected by collector 70 is a function of the motion of tape 80. In particular, the amount of light collected by collector 70 is a function of the position of edge 88. In addition, the amount of light collected by collector 70 is a function of beam angle θ. As tape edge 88 moves in lateral motion direction 86, the amount of light blocked by tape 80 varies according to a trigonometric function of angle θ.

The amount of light blocked by tape 80 is a function of movement in lateral motion direction 86 and also on the amount of “out of plane” movement of tape 80, i.e., the amount of motion of tape 80 away from bearing surface 72. In a typical application, however, tape 80 is taut against bearing surface 72, and the amount of “out of plane” motion is negligible.

FIG. 4 shows mirror 62 positioned with respect to perpendicular 90 by an angle φ. Positioning mirror 62 at angle φ directs reflected beam 64 on a path different from that of incident beam 60B. The invention encompasses embodiments in which mirror 62 directs reflected beam 64 back along the same path as incident beam 60B. As will be described below, some embodiments of the invention include a single assembly that includes both a light emitter and a collector, and directing reflected beam 64 along the incident path may be desirable. In other embodiments, however, there may be advantages to directing reflected beam 64 on a path different from that of incident beam 60B, however. One advantage may be that reflected beam 64 may be directed to an unobstructed path that will not be blocked by tape 80 or other obstacles. Another potential advantage is that the reflected light 64 is less likely to interfere with the operation of light emitter 52. When light emitter 52 includes a light source such as a laser, out-of-phase light reflected into the laser may, under some conditions, interfere with emission of the beam.

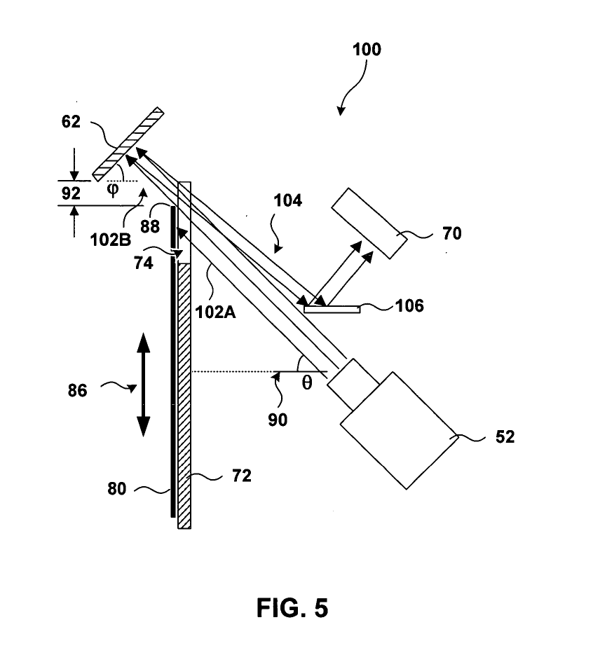

FIG. 5 presents a side view of an edge sensor 100 in an alternate embodiment of the invention. Edge sensor 100 is similar to edge sensor 50, in that edge sensor 100 includes light emitter 52 directing a beam obliquely with respect to the plane of tape 80. Edge sensor 100 is further similar to edge sensor 50 in that edge sensor 100 includes a mirror 62 and a collector 70. In addition, like edge sensor 50, light emitter 52 and collector 70 of edge sensor 100 are deployed posteriorly with respect to tape 80, and reflective mirror 62 is deployed anteriorly. Mirror 62 is further deployed to define clearance 92.

Unlike edge sensor 50, however, edge sensor 100 does not include a beam splitter. As a result, none of the beam emitted by light emitter 52 is lost by passing through a beam splitter. Portion 102A of the emitted light strikes tape 80 and is blocked. The remaining portion 102B does not strike tape 80, reaches reflective mirror 62, and is reflected.

Mirror 62 is deployed at an angle φ (not necessarily the same angle φ shown in FIG. 4) to direct reflected beam 104 to a second fully reflective mirror 106, which then reflects the light to collector 70. As shown in FIG. 5, mirror 106 is a plane mirror oriented with a plane substantially coincident with perpendicular reference line 90, but the invention encompasses other kinds of mirrors and orientations. Indeed, collector 70 may be deployed in any fashion, and mirror 106 may be deployed to direct reflected light 104 to collector 70. The arrangement depicted in FIG. 5 advantageously provides additional freedom in deploying collector 70.

Because edge sensor 100 does not include a beam splitter, light intensity is not lost by beam splitting. In some embodiments, the absence of a beam splitter may be advantageous.

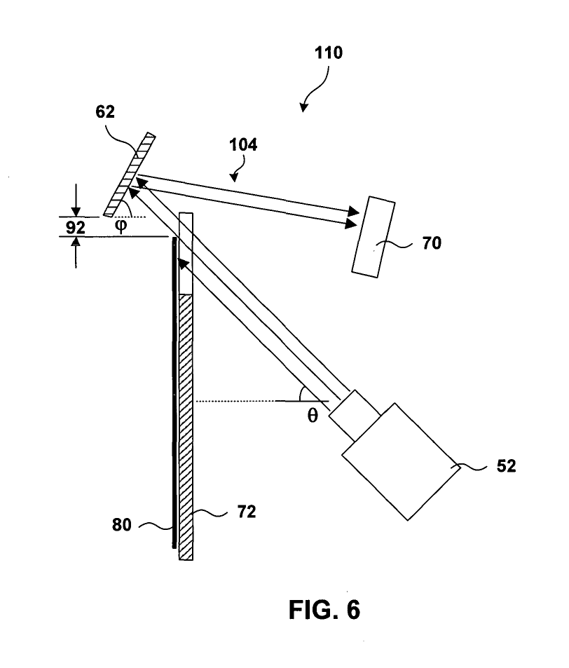

FIG. 6 presents a side view of an edge sensor 110 in an alternate embodiment of the invention. Edge sensor 110 is similar to edge sensor 50, in that edge sensor 110 includes light emitter 52 directing a beam obliquely with respect to the plane of tape 80, a mirror 62 and a collector 70. Once again, light emitter 52 and collector 70 of edge sensor 110 are deployed posteriorly with respect to tape 80, while reflective mirror 62 is deployed anteriorly to define clearance 92.

Edge sensor 110 does not include a beam splitter, nor does edge sensor 110 include a second mirror like mirror 106 shown in FIG. 5. Instead, mirror 62 is deployed at angle φ to direct reflected beam 104 directly to collector 70. Like edge sensor 100, edge sensor 110 does not lose light intensity by beam splitting.

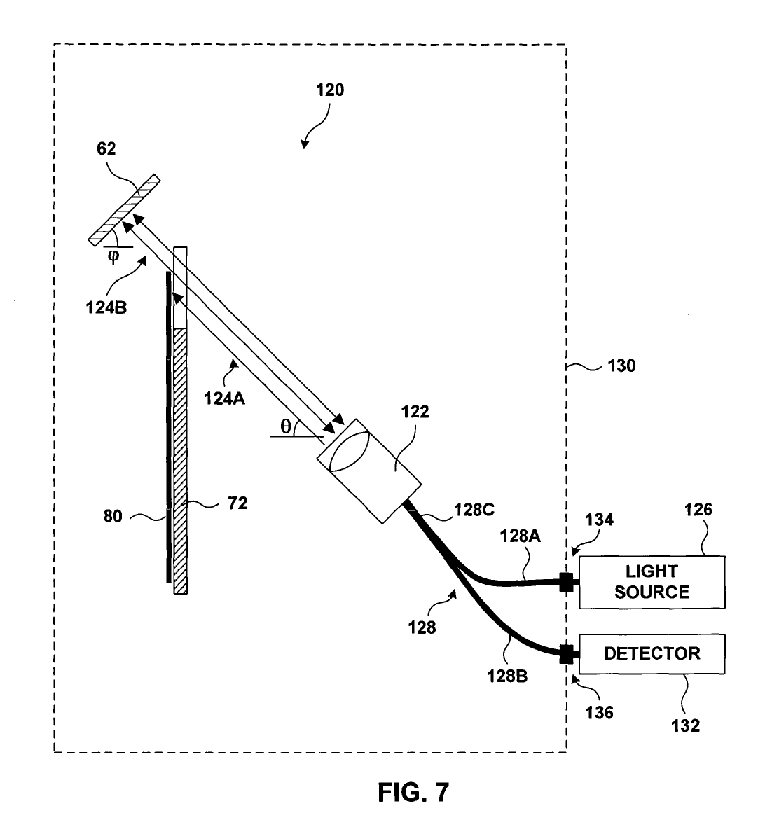

FIG. 7 presents a side view of an edge sensor 120 in an additional embodiment of the invention. Edge sensor 120 includes a collimating assembly 122 that emits light and receives reflected light. A portion 124A of the emitted light is blocked by tape 80, but the remaining portion 124B strikes mirror 60 and is reflected back along the incident path, where it is collected by collimating assembly 122. Collimating assembly 122 therefore serves as a light emitter and a light collector. Consequently, the light emitter and collector of edge sensor 120 are deployed posteriorly with respect to tape 80, while reflective mirror 62 is deployed anteriorly.

In the embodiment of FIG. 7, collimating assembly 122 does not generate the emitted beam of light. A light source 126 generates the light that is emitted by collimating assembly 122. Light source 126 may be, for example, a laser or one or more light emitting diodes. Light source 126 is optically coupled to collimating assembly 122 by an optical conduit 128, which will be described in more detail below. Light source 126 may be deployed at any location. In the embodiment shown in FIG. 7, light source 126 is deployed exteriorly, i.e., outside the media-handling device 130.

Collimating assembly 122 does not detect any qualities of the collected light, such as the intensity of the collected light. Rather, detector 132 detects the collected light. Detector 132 is optically coupled to collimating assembly 122 by optical conduit 128. Like light source 126, detector 132 may be deployed at any location. As shown in FIG. 7 detector 132 is deployed outside media-handling device 130.

Optical conduit 128 includes one or more optical fiber. As shown in FIG. 7, optical conduit 128 includes a dedicated fiber optic conduit 128A to light source 126 and a dedicated fiber optic conduit 128B to detector 132. The distal ends of dedicated fiber optic conduits 128A and 0.128B merge into a fiber optic coupler 128C, which in turn is coupled to collimating assembly 122. Light traveling in dedicated fiber optic conduits 128A and 128B commingles in fiber optic coupler 128C. As a result, fiber optic coupler 128C operates analogously to beam splitter 56 in FIGS. 2 and 4. In particular, a portion of the light collected by collimating assembly 122 is directed to detector 132, and another portion is directed back to light source 126 and is lost. Edge sensor 120 may be calibrated to take such losses into account.

The proximal ends of dedicated fiber optic conduits 128A and 128B terminate in sockets 134 and 136, to which light source 126 and detector 132 may be detachably coupled. The advantages associated with having a detachable light source 126 and detector 132 will be discussed below. The invention also includes embodiments in which light source 126 and detector 132 are installed inside media-handling device 130 and are not easily detachable.

In the embodiment depicted in FIG. 7, beam angle θ and the angle φ of mirror 62 substantially complement one another. In one embodiment of the invention, angles θ and φ are each forty-five degrees. In general, angles θ and φ are selected to direct reflected light back to collimating assembly 142 for collection.

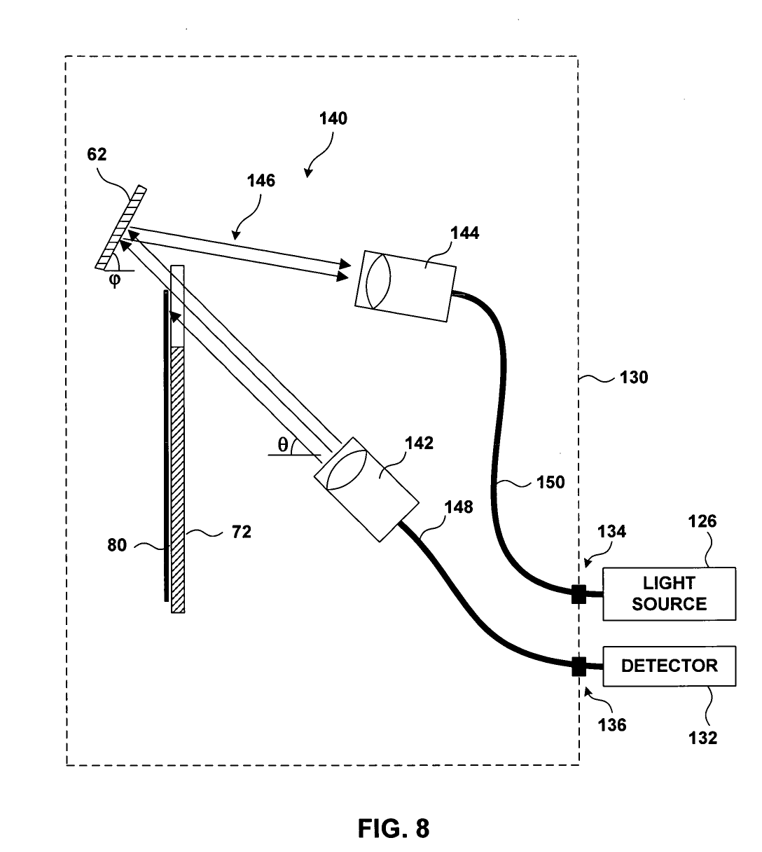

FIG. 8 presents a side view of an edge sensor 140 in another embodiment of the invention. Edge sensor 140 includes a collimating assembly 142 that emits light and a collector 144 that receives light reflected from mirror 62. Mirror 62 may be deployed at angle φ to direct reflected light 146 to collector 144. The light emitter and collector of edge sensor 140 are deployed posteriorly with respect to tape 80, while reflective mirror 62 is deployed anteriorly.

A light source 126 generates the beam of light that is emitted by collimating assembly 142. Light source 126 is optically coupled to collimating assembly 142 by a dedicated optical conduit 148. Detector 132 is optically coupled to collector 144 by a dedicated optical conduit 150. Detector 132 may be deployed at any location, including exteriorly. Because light source 126 and detector 132 do not share any optical paths, light losses that affect edge sensor 120 need not affect edge sensor 140.

Similar to edge sensor 120 shown in FIG. 7, edge sensor 140 does not include a light source or a detector. Instead, light source 126 and detector 132 are deployed exterior to media-handling device 130, and are detachable. Light source 126 and detector 132 may be deployed at other locations, however, and the invention includes embodiments in which light source 126 and detector 132 are installed inside media-handling device 130.

In embodiments of the invention depicted in FIGS. 7 and 8, light source 126 and detector 132 are deployed exteriorly and are detachable. These embodiments may be advantageous for inspection, troubleshooting or calibration of a device that manipulates a medium, such as tape-handling device 10 shown in FIG. 1. For example, the light emitter and collector may be mounted inside tape-handling device 10. The optical conduits may extend from the light emitter and collector to the exterior of tape-handling device 10. The optical conduits may be configured to be coupled to a light source or detector. For example, the proximal ends of the optical conduits can include one or more sockets, to which light source 126 and detector 132 may be detachably coupled.

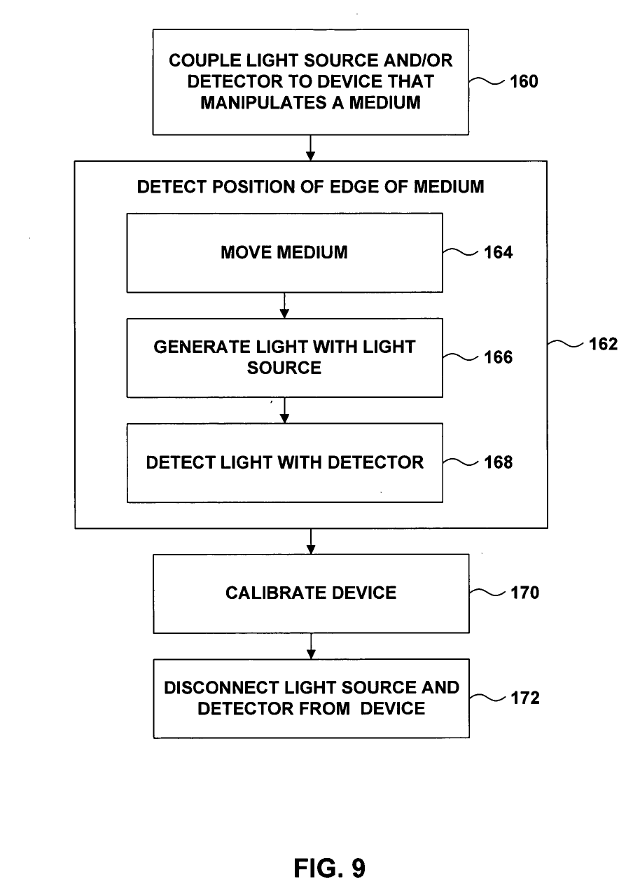

FIG. 9 is a flow diagram showing a technique for using edge sensors such as those depicted in FIGS. 7 and 8. Although the technique may be carried out by a machine, the technique will be described in the context of execution by an operator such as an inspector or a repairer.

The operator couples a light source or a detector or both to the media-handling device (160), e.g., by coupling the light source and detector to sockets that optically link the light source and detector, respectively, to a light emitter and collector deployed in the interior of the media-handling device. The operator uses the light source and detector to detect the position of the edge of a medium handled by the media-handling device (162).

An exemplary technique for edge detection includes causing the medium to move (164). In the case of tape-handling device 10, for example, the operator may cause tape-handling device 10 to thread a tape along tape path 14 and move the tape past head 12. The operator may also cause tape-handling device 10 to read data from or write data to the tape. While the medium is in motion, the operator may activate the light source, thereby generating light (166) that is transmitted by an optical conduit to the light emitter, where the light is emitted. At least a portion of the emitted light strikes a mirror and is reflected back to a collector, which transmits the reflected light by an optical conduit to the detector for detection (168). The position of the edge of the medium is a function of the quantity of light detected.

The operator may use the detected light for any purpose. In a typical application, the operator assesses the performance of the media-handling device. The operator may further calibrate the device to improve performance (170). When the operator is finished, the operator may disconnect the light source and detector from the media-handling device (172).

The various embodiments of the invention depicted in FIGS. 7-9 may be well suited for applications such as inspection, troubleshooting and calibration of media-handling devices. In some circumstances, it may not be practical or economical to install a light source and detector in every media-handling device. It may be more practical and economical to install a light emitter and a collector with optical conduits, which are generally less expensive. A light source or detector may be coupled to the media-handling device when desired, and detached when desired.

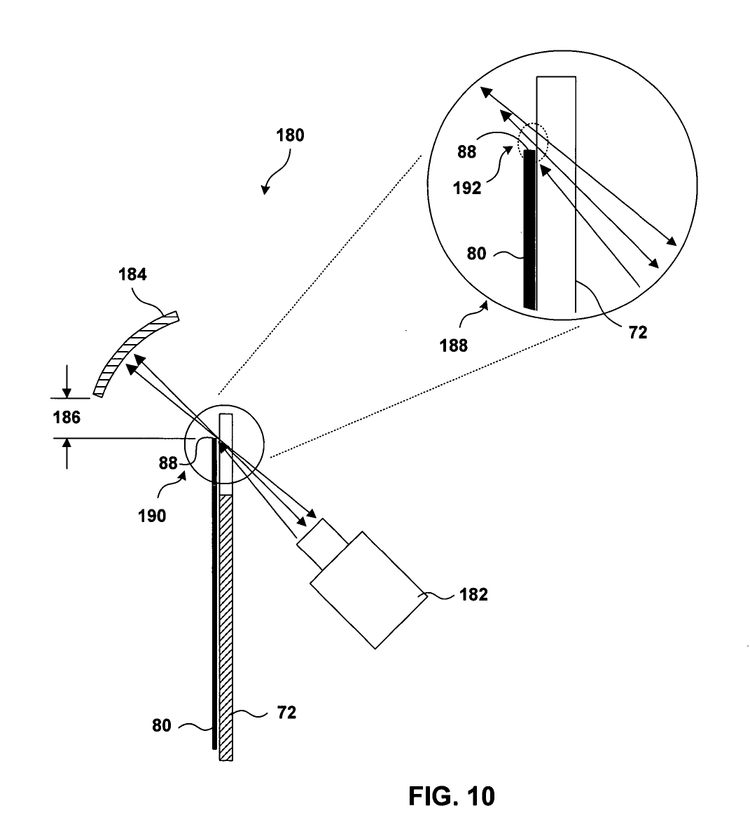

FIG. 10 presents a side view of an edge sensor 180 in another embodiment of the invention. Edge sensor 180 includes an assembly 182 that emits light and collects light reflected from mirror 184. The light emitter and collector of edge sensor 180 are deployed posteriorly with respect to tape 80, and mirror 184 is deployed anteriorly. Further, mirror 184 is deployed to define a clearance 186.

Light emitter/collector 182 emits a beam of light that is substantially focused. In particular, light emitter/collector 182 includes a focusing element, such as a lens or a shaped end of an optical conduit, to substantially focus the emitted beam and concentrate the light at a focal spot. The focused rays of light are directed obliquely with respect to the plane of tape 80, but the rays are directed at a variety of different angles due to focusing. Further, light emitter/collector 182 is deployed such that the focal spot that is proximate to edge 88 of tape 80. Mirror 184 is a spherical mirror, with a focus located proximate to the focal spot of light emitter/collector 182. Moreover, light emitter/collector 182 and mirror 184 are deployed such that an incident beam that strikes mirror 184 is reflected substantially back along the incident path of the beam, and is collected by light emitter/collector 182.

As shown in detailed view 188, which is an enlarged view of region 190, focal spot 192 is proximate to edge 88. Focal spot 192 need not be a sharp focal point. In the embodiment shown in FIG. 10, focal spot 192 is a region of small dimension rather than a precise focal point. In a typical embodiment, focal spot 192 may be substantially elliptical or circular, and have a major axis approximately 10 to 20 micrometers (microns) long. Light emitter/collector 182 is deployed such that tape edge 88 impinges on focal spot 192, blocking a portion of light emitted by emitter/collector 182, but not blocking the remaining portion.

An advantage of edge sensor 180 is sensitivity in some applications. Edge sensor 180 can detect minute lateral motions, such as lateral motion of tape 80 of a few micrometers. The sensitivity afforded by a substantially focused beam of light may be greater than the sensitivity afforded by a collimated beam of light.

In an alternative embodiment, light emitter/collector 182 may be supplanted by a collimating assembly, light source, detector and optical conduit such as are depicted in FIG. 7.

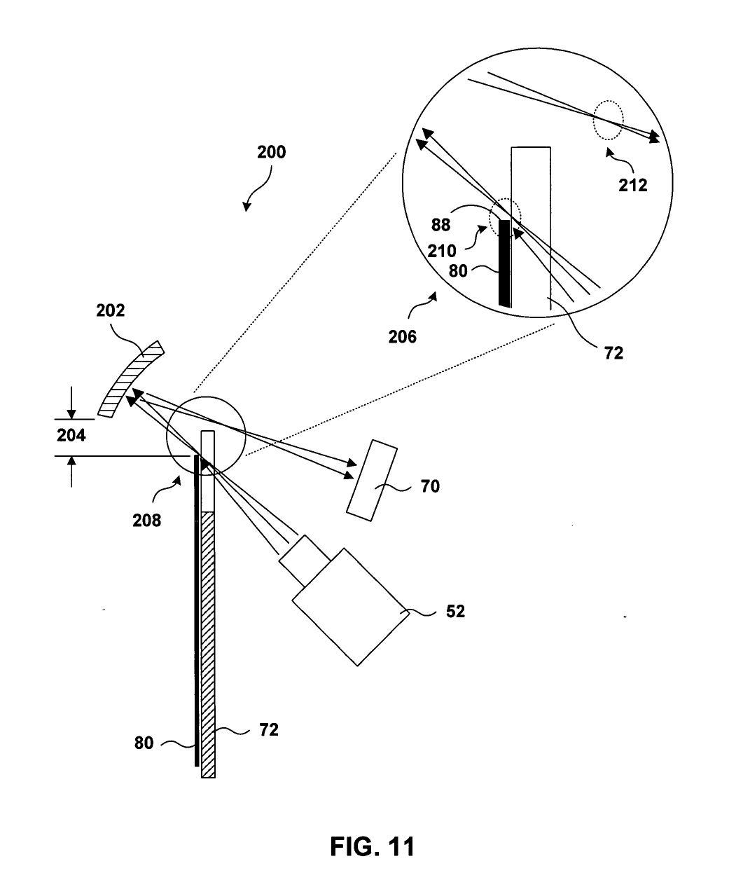

FIG. 11 presents a side view of an edge sensor 200 in another embodiment of the invention. Edge sensor 200 includes light emitter 52 and collector 70, which are deployed posteriorly with respect to tape 80. Edge sensor 200 also includes elliptical mirror 202, deployed anteriorly. Mirror 202 is deployed to define a clearance 204.

Elliptical mirror 202 has two foci. Incident light passing through one focus and striking mirror 202 will be reflected through the complementary focus. As shown in FIG. 11, light emitter 52 emits a beam of light that is substantially focused at a focal spot proximate to one of the foci of elliptical mirror 202. As shown in detailed view 206, which is an enlarged view of region 208, one focal spot 210 is proximate to edge 88. Light emitter 52 and mirror 202 are deployed such that an incident beam passes through focal spot 210 and, assuming the incident beam is unblocked by tape 80, is reflected through focal spot 212, which is proximate to the complementary focus of mirror 202. Collector 70 is deployed to receive the reflected light.

Similar to edge sensor 180 shown in FIG. 10, focal spot 210 need not be a sharp focal point, but can be a region of small dimension. In a typical embodiment, focal spot 210 may be substantially elliptical or circular, and have a major axis approximately 10 to 20 micrometers long. Light emitter 52 focuses the emitted beam such that tape edge 88 impinges on focal spot 210, blocking a portion of the emitted light, but not blocking the remaining portion. Use of elliptical mirror 202 substantially focuses the reflected beams through focal spot 212, which likewise need not be a sharp focal point. Focusing the reflected light through focal spot 212 prevents the reflected light from scattering. Like edge sensor 180, edge sensor 200 is advantageously sensitive in some applications, and can detect minute lateral motions.

The invention may offer one or more advantages, some of which are mentioned above. The various embodiments of the invention may be incorporated into the design of a media-handling device, or may be added on to a previously existing design. The various embodiments are configured to define a clearance, so that the mirror does not encroach upon the path of the medium, and so that an automatic loading apparatus can bring the medium proximate to the edge sensor without having to move the medium around edge sensor or retract or otherwise move the edge sensor.

The invention is versatile in application, and may be configured to work with a variety of media-handling devices. The invention is well suited for monitoring the edge of magnetic of optical tape, but the invention may be applied in other contexts as well. In some applications, the edge sensor may include a light source and detector installed in the media-handling device, and in other applications, the light source and detector may be attachable and detachable.

The invention encompasses a variety of deployments of components. The light emitter and collector, for example, may be deployed in a variety of positions. Beam splitters such as beam splitter 56, and mirrors such as mirror 106 may be deployed to direct incident or reflected light along paths in addition to those shown. One or more mirrors may also direct at least a portion of the emitted beam of light so that the light is directed obliquely with respect to the plane of the medium. Other optical elements, such as lenses and optical conduits, may be employed to direct incident or reflected light. The invention encompasses all of these variations.

Many embodiments of the invention have been described. Various modifications may be made without departing from the scope of the claims. For example, the invention is not limited to the particular kinds of mirrors shown. As described above, the mirror deployed on the anterior side of the medium may be a plane mirror, a spherical mirror or an elliptical mirror. The mirror may include any reflecting element, such as one or more prisms, a phase conjugate mirror, or one or more corner reflectors.

The embodiments of the invention depicted in FIGS. 1-8 and 10-11 show the medium against a bearing surface 72. Although a bearing surface is useful in reducing out of plane movement of the medium, the invention encompasses embodiments in which an edge sensor detects an edge of a medium at a sit where the medium is not bearing against a bearing surface.

Furthermore, the depicted deployments of light emitter and collector are exemplary, and the invention is not limited to the deployments shown. In some deployments, the positions of light emitter and collector may be reversed from the positions shown in the figures, with the medium blocking a portion of the reflected light, rather than a portion of incident light.

Features described in connection with the figures may be combined to create additional variations of the invention. For example, features of FIGS. 8 and 11 may be combined by replacing collimating assembly 142 with a focusing assembly, and plane mirror 62 with an elliptical mirror. The invention encompasses all of these variations.

These and other embodiments are within the scope of the following claims.

1. A device comprising:
a light emitter to emit a beam of light;
a mirror to reflect at least a portion of the emitted beam; and
a collector to receive at least a portion of the reflected portion of the emitted beam, the received portion comprising light unblocked by a data storage medium,
wherein the data storage medium comprises a first side and a second side, wherein the collector is disposed on the first side of the data storage medium, and wherein the mirror is disposed on the second side of the data storage medium.

2. The device of claim 1, further comprising a light source coupled to the light emitter.

3. The device of claim 2, wherein the light source comprises at least one of a laser and a light emitting diode.

4. The device of claim 1, wherein the light emitter comprises an optical conduit having a proximal end and a distal end, and wherein the distal end emits the beam of light.

5. The device of claim 4, wherein the proximal end of the optical conduit is configured to be coupled to a light source.

6. The device of claim 1, further comprising a detector coupled to the collector.

7. The device of claim 6, wherein the detector generates a signal as a function of the quantity of light received by the collector.

8. The device of claim 6, wherein the detector comprises a single-cell photodiode.

9. The device of claim 1, wherein the data storage medium comprises one of magnetic recording tape and optical recording tape.

10. The device of claim 1, further comprising a beam splitter disposed to direct at least a portion of the emitted beam of light to the mirror and to direct at least a portion of the reflected portion of the beam to the collector.

11. The device of claim 1, the light emitter comprising a collimating element to collimate the emitted beam.

12. The device of claim 1, the light emitter comprising a focusing element to substantially focus the emitted beam.

13. The device of claim 12, wherein the focusing element is configured to substantially focus the emitted beam to a focal spot having a major axis approximately 10 to 20 micrometers long.

14. The device of claim 1, wherein the data storage medium defines a plane, and wherein at least a portion of the emitted beam of light is directed obliquely to the plane.

15. The device of claim 14, wherein at least a portion of the emitted beam of light is directed at an angle of approximately forty-five degrees from a perpendicular to the plane.

16. The device of claim 1, wherein the emitter is disposed on the second side of the data storage medium.

17. The device of claim 1, wherein the mirror comprises at least one of a plane mirror, a prism, a phase conjugate mirror, a corner reflector, a spherical mirror and an elliptical mirror.

18. The device of claim 1, wherein at least a portion of the data storage medium is interposed between the light emitter and the mirror.

19. The device of claim 1, further comprising a base to hold the light emitter, mirror and collector in a fixed position with respect to one another.

20. A device comprising:
a light emitter to emit a beam of light;
a mirror to reflect at least a portion of the emitted beam; and
a collector to receive at least a portion of the reflected portion of the emitted beam, the received portion comprising light unblocked by a data storage medium,
wherein the data storage medium defines a plane, and wherein at least a portion of the emitted beam of light is directed obliquely to the plane.

21. The device of claim 20, wherein the light emitter emits the beam of light at an angle of approximately forty-five degrees from a perpendicular to the plane.

22. The device of claim 20, wherein the data storage medium comprises a first side and a second side, wherein the light emitter and collector are disposed on the first side of the data storage medium, and wherein the mirror is disposed on the second side of the data storage medium.

23. The device of claim 20, further comprising a light source coupled to the light emitter.

24. The device of claim 20, wherein the light emitter comprises an optical conduit having a proximal end and a distal end, and wherein the distal end emits the beam of light.

25. The device of claim 20, further comprising a detector coupled to the collector.

26. The device of claim 20, wherein the data storage medium comprises one of magnetic recording tape and optical recording tape.

27. The device of claim 20, further comprising a beam splitter so disposed to direct at least a portion of the emitted beam of light to the mirror and to direct at least a portion of the reflected portion of the beam to the collector.

28. The device of claim 20, the light emitter comprising a collimating element to collimate the emitted beam.

29. The device of claim 20, the light emitter comprising a focusing element to substantially focus the emitted beam.

30. The device of claim 20, wherein the mirror comprises at least one of a plane mirror, a prism, a phase conjugate mirror, a corner reflector, a spherical mirror and an elliptical mirror.

31. The device of claim 20, wherein at least a portion of the data storage medium is interposed between the light emitter and the mirror.

32. The device of claim 20, further comprising a base to hold the light emitter, mirror and collector in a fixed position with respect to one another.

33. A device comprising:
a first optical conduit having a first proximal end and a first distal end, wherein the first distal end is configured to emit a beam of light when a light source is coupled to the first proximal end;
a mirror to reflect at least a portion of the emitted beam; and
a second optical conduit having a second proximal end and a second distal end, wherein the second distal end is configured to receive at least a portion of the reflected portion of the emitted beam, wherein the received portion comprises light unblocked by a data storage medium, and wherein the second proximal end is configured to be coupled to a detector.

34. The device of claim 33, wherein the first optical conduit includes at least one optical fiber.

35. The device of claim 33, wherein the first distal end of the first optical conduit and the second distal end of the second optical conduit include a coupler configured to direct at least a portion of the reflected portion of the emitted beam into the first optical conduit.

36. The device of claim 35, further comprising one of a collimating assembly and a focusing assembly coupled to the coupler to emit the beam of light and to receive the portion of the reflected portion of the emitted beam.

37. The device of claim 33, further comprising a socket coupled to the first proximal end of the first optical conduit, the socket configured to receive a light source.

38. The device of claim 33, further comprising one of a collimating assembly and a focusing assembly coupled to the first distal end of the first optical conduit.

39. The device of claim 33, further comprising a collector coupled to the second distal end of the second optical conduit.

40. A method comprising:
emitting a beam of light from a first side of a data storage medium; and
collecting at least a portion of the emitted beam on the first side of the data storage medium, the collected portion comprising light reflected in a mirror disposed on a second side of the data storage medium and unblocked by the data storage medium.

41. The method of claim 40, wherein the data storage medium defines a plane, the method further comprising directing at least a portion of the emitted beam of light obliquely to the plane.

42. The method of claim 40, further comprising:
detecting the amount of collected light; and
measuring the position of an edge of the data storage medium as a function of the detected amount of collected light.

43. The method of claim 40, wherein emitting the beam of light further comprises emitting a collimated beam of light.

44. The method of claim 40, wherein emitting the beam of light further comprises emitting a substantially focused beam of light.
